(19) United States
(12) Patent Application Publication
(10) Pub. No.: US 2008/0315583 A1
(43) Pub. Date: Dec. 25, 2008

(54) Hybrid Propulsion System For a Watercraft

(76) Inventors: Oliver Beck, Den Haag (NL); Wil van Mol, Singapore (SG)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/097,335

(22) PCT Filed: Oct. 11, 2006
(86) PCT No.: PCT/EP2006/067259

§ 371 Date: Jun. 13, 2008

(30) Foreign Application Priority Data
Dec. 14, 2005 (DE) 10 2005 059 761.0

(51) Int. Cl. F02N 11/04

(52) U.S. Cl. 290/31

(57) ABSTRACT

A propulsion system for a watercraft is described, having a diesel engine (4), a propeller (2), at least one auxiliary generator set (12), a generator (6) and a drive unit for at least one machine, in which case the diesel engine (4) can be connected on the one hand to the propeller (2) and on the other hand by means of the generator (6) to a power supply system (10) in the watercraft, and with the drive unit for machines having at least one converter (34, 36, 38, 62) which can be connected on the one hand to the power supply system (10) and on the other hand to the machines. At least one converter (34, 36, 38, 62) for the drive unit for machines can be connected on the load side to the generator (6).

The invention relates to a propulsion system for a watercraft, as claimed in the preamble of claim 1.

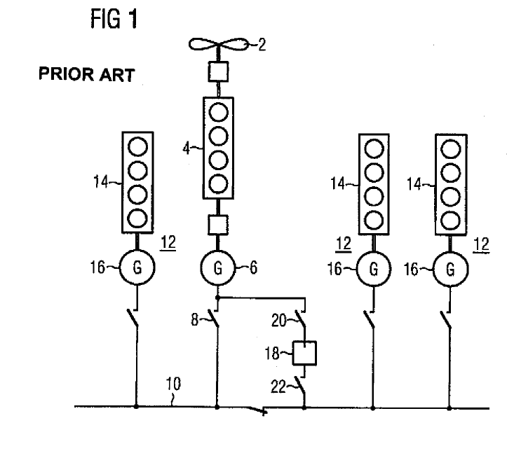

In a simple propulsion system for watercraft, this propulsion system as shown in FIG. 1 has only one propeller 2 or vessel screw 2, which is driven via a diesel engine 4, also referred to as the main diesel. This diesel engine 4 drives not only the propeller 2, but likewise a generator 6 which can be connected on the load side to an on-board power supply system 10 by means of a contactor 8. In addition, this propulsion system has at least one auxiliary generator set 12. FIG. 1 shows three auxiliary generator sets 12, which each comprise a diesel engine 14 and an electrical generator 16. The diesel engine 14 in each auxiliary generator set 12 is also referred to as auxiliary diesel. The electrical generators 16 are each linked on the load side to the on-board power supply system 10 in the watercraft. In order to ensure that a watercraft with a propulsion system such as this can still enter a harbor safely if the main diesel 4 fails, this propulsion system additionally has a converter 18 which is used on the one hand to start the generator 6 and on the other hand to operate the generator 6 as a motor if the main diesel fails. For this reason, this converter 18 has a contactor 20 and 22, respectively, on the generator side and on the on-board power supply system side. When the generator 6 is being operated as a motor from the on-board power supply system 10 by means of the converter 18, then this operating state is referred to as power take in (PTI). In contrast, when the generator 6 is electrically conductively connected to the on-board power supply system 10, then this operating state is referred to as power take off (PTO).

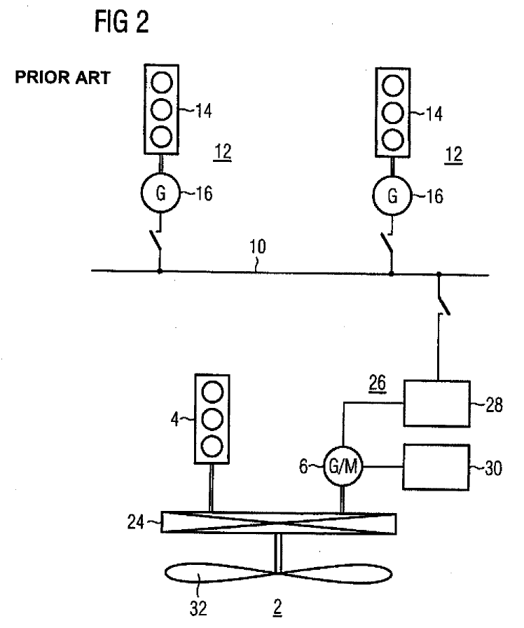

The publication “WGA 23—ein modernes Wellengeneratorsystem” [WGA 23—a modern shaft generator system] by Rolf Buschen printed in the German Journal “HANSA”, Year 120, Number 13, 1983, July issue, pages 1203-1207 discloses a further propulsion system for watercraft, which is illustrated schematically in FIG. 2, in order to explain it in more detail. This known propulsion system has a diesel engine 4, a gearbox 24, a propeller 2, at least one diesel generator set 12 and a machine system 26. The diesel engine 4 is connected by means of the gearbox 24 to the propeller 2 for the watercraft. In addition, the machine system 26 is connected to the propeller 2 by means of the gearbox 24.

In this known propulsion system, the machine system 26 has a generator 6, which in this publication is referred to as shaft generator, a current-source d.c.-link converter 28 and an exciter device 30. The shaft generator 6 can be electrically conductively connected on the stator side to the on-board power supply system 10, by means of the current-source d.c.-link converter 28. The exciter device 30 has, for example, an exciter converter with a matching transformer and is electrically conductively connected to the field winding of the shaft generator 6. The rotor of this shaft generator 6 is connected to the gearbox 24. An externally excited synchronous machine is provided as the shaft generator 6, and is normally operated as a generator.

The current-source d.c.-link converter 28 has a rectifier on the generator side and an inverter on the on-board power supply system side, and decouples the frequency of the on-board power supply system 10 from that of the shaft generator 6. The rectifier and the inverter in the current-source d.c.-link converter 28 are connected to one another on the direct-current side by means of a d.c. link. This d.c. link is formed by means of an inductor, which is required in order to make it possible to limit converter currents in the event of a fault or short circuit. This d.c. link converter 28 is provided on the on-board power supply system side with a power supply system inductor in order to limit short-circuit current and harmonics.

Since loads which require a reactive current are also connected to the on-board power supply system 10, the machine system 26 also has a Wattless component generator with a manually-started single-phase motor fitted to it, although this is not illustrated in any more detail, for clarity reasons.

In the publication cited above, the sketched machine model 26 is referred to as a shaft-generator system. Electrical energy is generated at low cost on a watercraft by means of the shaft generator of this shaft-generator system, which is driven by the main diesel 4, by means of the gearbox 24.

Since both the rectifier and the inverter in the current-source d.c.-link converter 28 are equipped with thyristors, this current-source d.c.-link converter 28 can also transmit power in the opposite direction, that is to say from the on-board power supply system 10 to the shaft generator 6. In this case, the shaft generator 6 operates as a motor and, for example, can be used for emergency vessel propulsion. The main diesel 4 is switched off in this mode. The energy to operate this shaft generator 6 as a motor is provided by diesel generator sets 12, which each have a diesel engine 14 and an electrical generator 16.

In order to allow the main diesel 4 to be operated economically, it is operated at a constant, for example rated, rotation speed. In order to allow the speed of the watercraft to be controlled, the propeller 2 has variable-pitch propeller blades 32.

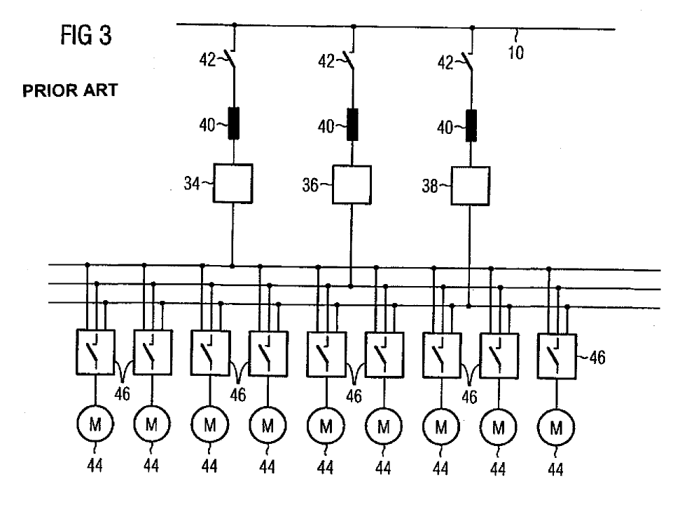

In addition to this propulsion system, some watercraft also have at least one appliance, for example a pump, which is likewise electrically powered. FIG. 3 shows a drive unit for loading and discharge pumps. For clarity reasons, the pumps are not illustrated explicitly. According to this illustration, this drive unit has three converters 34, 36 and 38, each of which has an upstream inductor 40 on the on-board power supply system side. These inductors 40 can each be electrically conductively connected to the on-board power supply system 10 in the watercraft by means of a contactor 40. A three-phase voltage power supply system with a variable voltage and a variable frequency is available on the load side of each converter 34, 36 and 38. Each motor 44 of a pump for a loading and discharge pump arrangement can be connected by means of a switch device 46 to one of these three three-phase voltage power supply systems that are produced. This means that each three-phase voltage power supply system can be set to a predetermined variable voltage and frequency independently of the two other three-phase voltage power supply systems. This is advantageous when the loading and discharge pumps that are provided have different operating voltages and rotation speeds. A drive unit such as this is used only when the watercraft is moored on the quay in a harbor and is being loaded or unloaded. Since the times for which a watercraft remains in the harbor are negligible in comparison to the times during which it is at sea, the financial viability of this drive unit for the watercraft is low from the point of view of a shipowner.

The invention is now based on the object of further developing the known propulsion system for watercraft such that it is simpler.

According to the invention, this object is achieved by the characterizing feature of claim 1 and of claim 2.

Since at least one of the converters in the drive unit can be connected from the load side to the generator, this saves the previous converter for the generator driven by the main diesel. Since this converter is used only when the watercraft is not being unloaded or loaded, the function of this converter can also be carried out by at least one of the converters of the drive unit. This saving of the converter for starting up the generator and for operating the generator as a motor in the PTI operating mode saves space and weight.

In the case of a propulsion system as claimed in claim 2, which is also known as a shaft-generator system, not only the converter for this shaft-generator system but also the starting transformer are saved.

A propulsion system designed according to the invention for a watercraft therefore saves not only space and weight but also investment costs.

In order to explain the invention further, reference is made to the drawing, which schematically illustrates embodiments of the propulsion system according to the invention for a watercraft.

FIG. 1 shows a simple known propulsion system for a watercraft,

FIG. 2 shows a detail of a known shaft-generator system,

FIG. 3 shows a known drive unit for loading and discharge pumps,

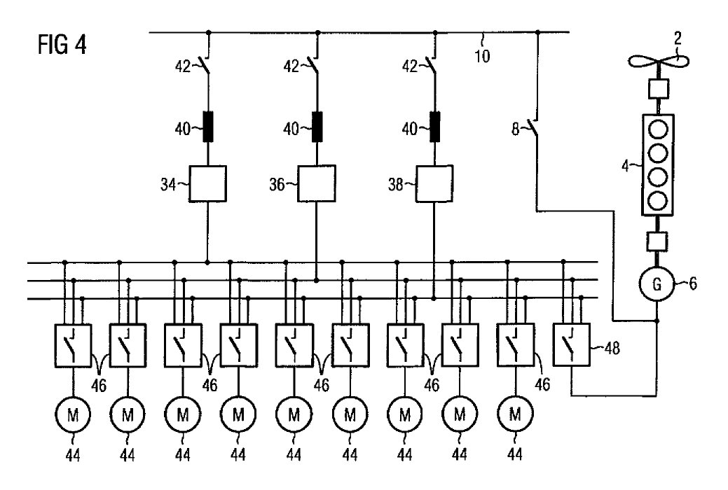

FIG. 4 shows a first embodiment of a propulsion system according to the invention, while in contrast

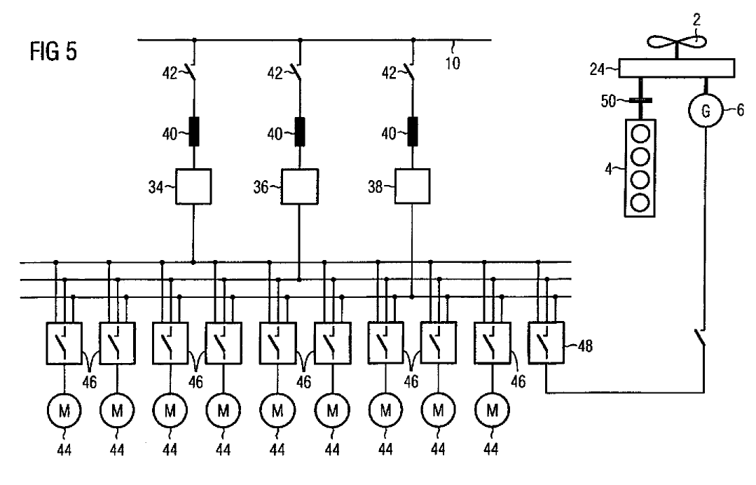

FIG. 5 shows a second embodiment of a propulsion system according to the invention,

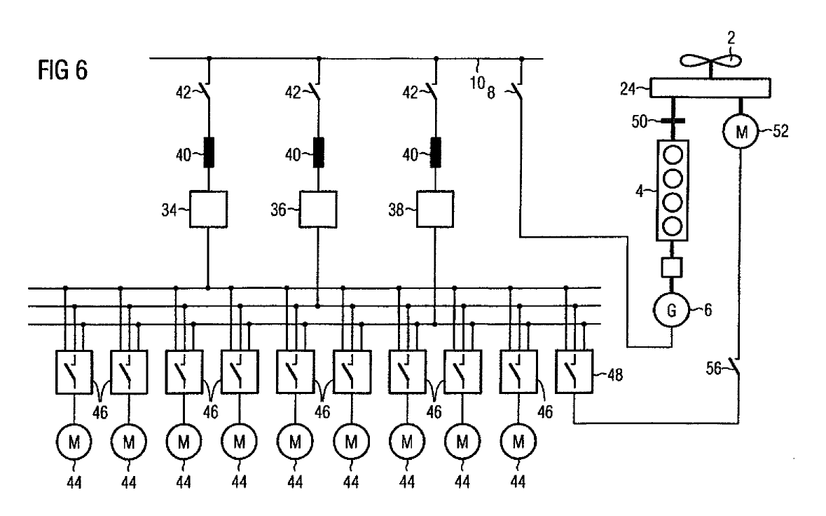

FIG. 6 shows a third embodiment of a propulsion system according to the invention,

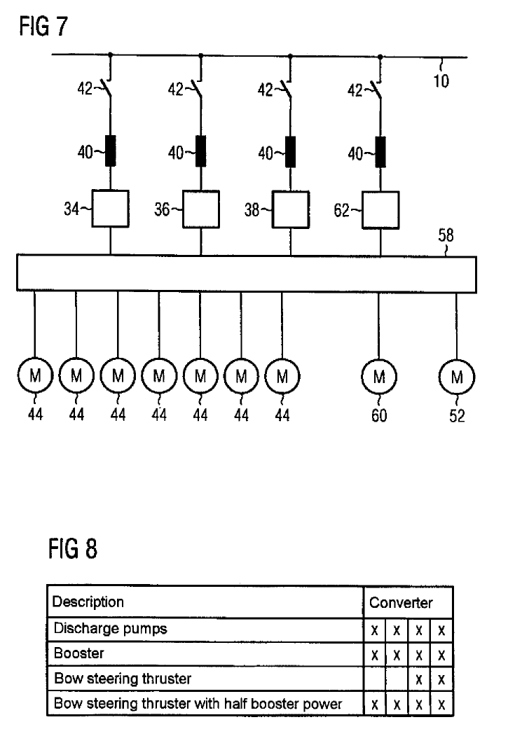

FIG. 7 shows a universal drive unit for a propulsion system according to the invention,

FIG. 8 shows a table for the connection of a plurality of converters in the drive unit as shown in FIG. 7, and

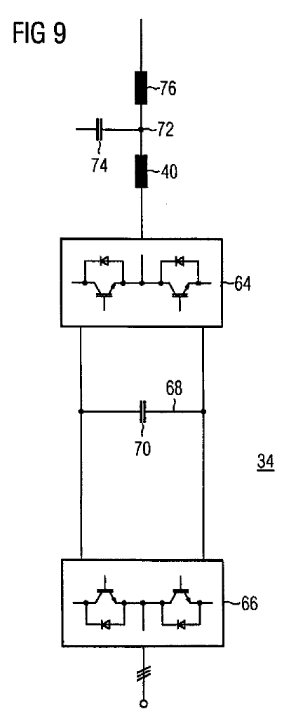

FIG. 9 shows an outline circuit diagram of a voltage-source converter, with a feedback capability, for the drive unit shown in FIGS. 3 and 7.

FIG. 4 shows a first embodiment of a propulsion system for a watercraft according to the invention. This propulsion system according to the invention is characterized in that the generator 6 in FIG. 1 can be connected by means of an additional switch device 48 to at least one of the three three-phase voltage power supply systems, which are each connected to a respective converter 34, 36 and 38 in the drive unit for at least one appliance. This switch device 48 is designed in precisely the same way as the switch devices 46 for the known drive unit for the loading and discharge pumps. This means that one, two or three three-phase voltage power supply systems that are produced can be connected in parallel by means of this switch device 48. How many of these three converters 34, 36 and 38 and therefore how many of the generated three-phase voltage power supply systems need be connected in parallel depends on the energy required to start up the generator 6. Once the generator 6 has been started up, the contactor 8 is closed, thus resulting in the generator 6 acting as a motor (PTI). The switch device 48 is opened again since, when no faults are present, the converter or converters 34, 36, 38 are no longer required for propulsion. The connection according to the invention of the drive unit for the loading and discharge pumps to the propulsion unit for the propeller 2 results in a propulsion system for a watercraft which saves at least the converter 18 in FIG. 1, in comparison to a known propulsion system. Functionally, this changes nothing.

The embodiment of the propulsion system shown in FIG. 5 is created by the drive unit as shown in FIG. 3 being connected according to the invention to the drive unit as shown in FIG. 2. This connection according to the invention saves the current-source d.c.-link converter 28 in FIG. 2. According to the second embodiment of the propulsion system according to the invention, the generator 6 can be electrically conductively connected to the on-board power supply system 10 by means of at least one converter 34, 36 or 38. The number of converters 34, 36 or 38 to be used in the drive unit for the loading and discharge pumps depends on the electrical power which is generated by the generator 6. On the on-board power supply system side, the switch device 48 can be used to connect the generator 6 to one of the three converters 34, 36 or 38, to two parallel-connected converters 34, 36; 36, 38 or 38, 34, or to three parallel-connected converters 34, 36 and 38. If the main diesel 4 fails and can then be disconnected from the gearbox 24 by means of a clutch 50, the link according to the invention between the two drive units is maintained, with the converters 34, 36 and 38 that are used now being controlled such that energy can then be passed from the on-board power supply system 10 to the generator 6. The generator 6 is therefore operated as a motor, thus allowing emergency operation to be maintained.

FIG. 6 shows a third embodiment of the propulsion system according to the invention in more detail. This differs from the embodiment shown in FIG. 4 in that a booster motor 52 is also provided. This additional booster motor 52 is connected to the propeller 2 of the watercraft by means of the gearbox 24. This propulsion unit for the propeller 2 is a so-called hybrid propulsion system. The energy for the booster motor 52 is provided from the on-board power supply system 10.

Once the generator 6 has been started up, it is electrically conductively connected directly to the on-board power supply system 10 on the on-board power supply system side. The booster motor 52 is connected by means of the switch device 48 to a predetermined number of converters 34, 36 or 38 in the drive unit for loading and discharge pumps. The energy supplied to the booster motor 52 can be controlled with the aid of the converter or converters 34, 36, 38 in this drive unit.

FIG. 7 shows a universal drive unit for a propulsion system according to the invention. In this illustration, all the switch devices 46 and additional switching devices 48 as shown in FIGS. 4, 5 and 6 are combined in a matrix device 58. A multiplicity of electric motors 44, 52 and 60 are connected to the load side. 44 denotes the electric motors for loading and discharge pumps in FIG. 4, 5 or 6, 52 denotes the booster motor in FIG. 6, and 60 denotes the electric motor for a bow steering thruster. On the on-board power supply system side, four converters 34, 36, 38 and 62 are connected on the output side to the connections of the matrix device 58 in this illustration. As shown in FIG. 4, 5 or 6, each converter 34, 36, 38 and 62 can be electrically conductively connected on the on-board power supply system side to the on-board power supply system 10 of the watercraft, by means of an inductor 40 and a contactor 42. In contrast to FIGS. 4, 5, 6 or this illustration, this drive unit may also have only two or else more than four converters 34, 36, 38 and 62.

FIG. 8 shows a table showing how many of these four converters 34, 36, 38 and 62 are required for the individual drive and propulsion tasks. By way of example, two converters, specifically the converters 38 and 62, are required to drive the motor 60 for the bow steering thruster. How many of the installed converters in the drive unit in the propulsion system for a watercraft are required for individual drive and propulsion tasks depends primarily on the total required power and on the powers of the converters.

FIG. 9 shows in more detail an outline circuit diagram of a voltage-source converter 34, 36, 38 or 62 with a feedback capability. These voltage-source converters 34, 36, 38, 62 with a feedback capability are linked to the matrix device 58 and to the on-board power supply system 10 such that its converter 64 on the power supply system side can in each case be connected by means of a contactor 42 to the on-board power supply system 10, and such that its converter 66 on the load side can in each case be connected to inputs of the matrix device 58. According to this outline circuit diagram, the converter 64 on the power supply system side and the converter 66 on the load side are electrically conductively connected to one another on the DC voltage side by means of a DC voltage-source 68, formed from at least one electrolytic capacitor 70. On the AC voltage side, the converter 64 on the power supply system side has a power supply system filter 72 which has a filter capacitor 74 and two filter inductors 40 and 76. The converter 64 on the power supply system side with the inductor 40 on the input side is also referred to in converter technology as an active front end (AFE). According to this outlined circuit diagram of the voltage-source converter 34, 36, 38 or 62 with a feedback capability, insulated gate bipolar transistors, so-called IGBTs, are in each case provided as converter valves for the converter 64 on the power supply system side and for the converter 66 on the load side. It is, of course, also possible to use any other semiconductor switches which can be turned off as converter valves for each of these two converters 64 and 66. A self-commutated, pulsed feed/feedback converter using IGBT technology in conjunction with the filter results in a negligible reaction on the power supply system and allows power-factor correction. A converter device with this outline circuit diagram is commercially available as a converter switchgear cabinet (Siemens Catalogue D21.3, May 2004, entitled “SINAMICS S150—Umrichter-Schalt-schränke 75 kW bis 1200 kW” [Converter switchgear cabinet, 75 kW to 1200 kW]).

In this propulsion system according to the invention for a watercraft, comprising a propulsion unit for the propeller 2 and a drive unit for appliances, these two drive propulsion units are linked to one another. The drive unit for the appliances is therefore used for further drive and propulsion tasks. This saves at least one converter unit for the propulsion unit for the propeller 2. This saving reduces the space required and the weight of the propulsion system according to the invention. In addition, the installed propulsional power is used over a much longer operating time, thus considerably improving the financial viability of this propulsion system.

1.-10. (canceled)

11. A propulsion system for a watercraft, comprising:
a propeller;
a generator;
a diesel engine configured for connection to the propeller and via the generator to an on-board power supply system in the watercraft;
at least one auxiliary generator set;
a drive unit for operating at least one appliance, said drive unit having at least one converter configured for connection to the on-board power supply system and to the appliance; and
a switching device for connecting a load side of the at least one converter, which is configured for connection to the appliance, to the generator.

12. The propulsion system of claim 11, further comprising a gearbox connecting the generator and the diesel engine to the propeller.

13. The propulsion system of claim 11, further comprising a matrix device connecting the appliances and the generator to the load-side of the at least one converter.

14. The propulsion system of claim 11, wherein the at least one converter is configured as a DC-link converter.

15. The propulsion system of claim 11, wherein the auxiliary generator set comprises a diesel engine and an electric generator.

16. The propulsion system of claim 11, wherein the appliance is a pump.

17. The drive system of claim 11, wherein the appliance is a bow steering thruster.

18. A propulsion system for a watercraft, comprising:
a propeller;
a diesel engine configured for connection to the propeller;
a generator connected to an on-board power supply system of the watercraft;
at least one auxiliary generator set;
a booster motor,
a gearbox connecting the diesel engine, the booster motor and the propeller,
a drive unit for operating at least one appliance, said drive unit having at least one converter configured for connection to the on-board power supply system and to the appliance, and
a switching device for connecting a load side of the at least one converter, which is configured for connection to the appliance, to the booster motor.

19. The propulsion system of claim 18, further comprising a clutch arranged between the diesel engine and the gearbox.

20. The propulsion system claim 18, wherein the at least one converter is configured as a voltage-source converter having feedback capability.

21. The propulsion system of claim 18, further comprising a matrix device connecting the appliances and the generator to the load-side of the at least one converter.

22. The propulsion system of claim 18, wherein the at least one converter is configured as a voltage-source converter.

23. The propulsions system of claim 18, wherein the auxiliary generator set comprises a diesel engine and an electric generator.

24. The propulsion system of claim 18, wherein the appliance is a pump.

25. The propulsion system of claim 18, wherein the appliance is a bow steering thruster.
